(19) United States
(12) Patent Application Publication
(10) Pub. No.: US 2021/0042131 A1
(43) Pub. Date: Feb. 11, 2021

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Yuichi Yagi, Tokyo (JP)

(21) Appl. No.: 16/940,736

(22) Filed: Jul. 28, 2020

(30) Foreign Application Priority Data
Aug. 9, 2019 (JP) 2019-147964

(51) Int. Cl. G06F 9/445; G06F 8/61; G06F 9/455

(52) U.S. Cl. CPC G06F 9/44505; G06F 2009/45591; G06F 9/45558; G06F 8/61

(57) ABSTRACT

An information processing apparatus is capable of extending functions by installing an extension application as an add-in. The information processing apparatus stores and manages setting data of each application, and reads setting data of an application of another device and rewrites setting data of a corresponding extension application that the information processing apparatus has. The information processing apparatus activates the extension application and edits the setting data, and, in a case that the setting data is edited, if a setting value of the setting data differs between the another device and the information processing apparatus, converts the differing setting value to a setting value based on configuration information of the information processing apparatus.

### BACKGROUND OF THE INVENTION

### Field of the Invention

The present invention relates to an information processing apparatus, a method of controlling the same, and a storage medium.

### Description of the Related Art

Systems in which the functionality of an image forming apparatus can be extended by installing an extension program on the image forming apparatus as an add-in have been proliferating. Such systems have a separate execution environment in which the extension programs run in addition to an execution environment in which a control program of the image forming apparatus. An extension application includes the extension program and resources such as image data.

Japanese Patent Laid-Open No. 2013-69077 describes a system comprising an image forming apparatus capable of executing the installation of an application that has been provided thereto and an information processing apparatus that provides a development environment for applications that the image forming apparatus executes. Also, Japanese Patent Laid-Open No. 2013-69077 describes that the information processing apparatus generates an application including a test program for verifying functions that an application is to provide, and a test agent program for issuing commands for starting the execution of the test program in accordance with an instruction from the information processing apparatus, and transmitting the application to the image forming apparatus.

Also, Japanese Patent Laid-Open No. 2014-120824 describes an image forming apparatus that, in a case where a setting item differs from an item of the image forming apparatus or a range of setting items differs from a range of the image forming apparatus when setting information is received from another device, stores setting values that are based on user settings in place of the received setting information.

However, in the case where setting data for a plurality of extension applications of other image forming apparatuses is imported where the setting item differs or the range of the setting value differs, it is necessary to determine whether there is a difference in the setting item and whether the range of the setting value differs for each extension application, and to convert the setting value as necessary and store the converted setting value. For that purpose, since it is necessary to activate each extension application when setting data is imported, there was the problem that the period over which the user could not use the extension application during the import of a plurality of extension applications until the completion thereof took a long time.

### SUMMARY OF THE INVENTION

An aspect of the present invention is to eliminate the above-mentioned problem with conventional technology.

The feature of the present invention is to provide a technique in which a user can use an application immediately when setting data of an extension application is imported.

According to a first aspect of the present invention, there is provided an information processing apparatus being capable of extending functions by installing an extension application as an add-in, the information processing apparatus comprising: at least one processor and at least one memory configured to function as: a management unit that stores and manages setting data of each application; a rewriting unit that reads setting data of an application of another device and rewrites setting data of a corresponding extension application that the information processing apparatus has; an editing unit that activates the extension application and edits the setting data; and a converting unit that, in a case that the setting data is edited by the editing unit, in a case where a setting value of the setting data differs between the another device and the information processing apparatus, converts the differing setting value to a setting value based on configuration information of the information processing apparatus.

According to a second aspect of the present invention, there is provided an information processing apparatus being capable of extending functions by installing an extension application as an add-in, the information processing apparatus comprising: at least one processor and at least one memory configured to function as: a management unit that stores and manages setting data of each application; a rewriting unit that reads setting data of an application of another device and rewrites setting data of a corresponding extension application that the information processing apparatus has; an execution unit that executes, in a case that the extension application is activated, a job by the extension application in accordance with setting data corresponding to the extension application; and a converting unit that, in a case that the execution unit executes the job, in a case where a setting value of the setting data differs between the another device and the information processing apparatus, converts the differing setting value to a setting value based on configuration information of the information processing apparatus, and sets the result of the conversion to the job.

According to a third aspect of the present invention, there is provided a method of controlling an information processing apparatus that is able to extend functions by installing an extension application as an add-in, the method comprising: managing and storing setting data of each application; reading setting data of an application of another device and rewriting setting data of a corresponding extension application that the information processing apparatus has; activating the extension application and editing the setting data; and in a case that the setting data is edited, in a case where a setting value of the setting data differs between the another device and the information processing apparatus, converting the differing setting value to a setting value based on configuration information of the information processing apparatus.

According to a fourth aspect of the present invention, there is provided a method of controlling an information processing apparatus that is able to extend functions by installing an extension application as an add-in, the method comprising: managing and storing setting data of each application; reading setting data of an application of another device and rewriting setting data of a corresponding extension application that the information processing apparatus has; executing, in a case that the extension application is activated, a job by the extension application in accordance with setting data corresponding to the extension application; and in a case that the job is executed, in a case where a setting value of the setting data differs between the another device and the information processing apparatus, converting the differing setting value to a setting value based on configuration information of the information processing apparatus, and setting the job.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for describing a configuration of a main part of an image forming apparatus according to the embodiment of the present invention.

FIG. 2 is a block diagram for describing one example of an execution environment of an extension application in the image forming apparatus according to the embodiment.

FIG. 3 is a configuration diagram of software modules that a CPU of the image forming apparatus according to the embodiment executes.

FIG. 4 depicts a view illustrating a configuration example of a print system which includes the image forming apparatus according to the embodiment.

FIGS. 5A and 5B depict views illustrating one example of information of an extension application stored in a storage of the image forming apparatus according to the embodiment.

FIG. 6 is a sequence diagram for describing a flow of setting processing of an application in the image forming apparatus according to the embodiment.

FIGS. 7A and 7B depict views illustrating examples of a setting screen of a form printing application displayed on a Web browser according to the embodiment.

FIG. 8 depicts a view illustrating an example of a screen is displayed on a console unit of the image forming apparatus according to the embodiment.

FIG. 9 is a sequence diagram for describing processing for when an extension application is activated in the image forming apparatus according to the embodiment.

FIG. 10 depicts a view for describing an overview of processing for reflecting application setting information of an image forming apparatus 404 to an image forming apparatus 401 according to the embodiment.

FIGS. 11A and 11B depict views illustrating one example of configuration information of the image forming apparatus which is obtained by an extension application by using an extension VM system service in the embodiment.

FIG. 12 is a flowchart for describing processing which determines setting data for describing an HTML form when an application setting is executed in a state where setting data having differing configuration information is imported in the image forming apparatus according to the embodiment.

FIG. 13 is a flowchart for describing processing for when a form printing application inputs a job in a state where setting data having differing configuration information is imported in the image forming apparatus according to the embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note, in the embodiments described below, one example of an information processing apparatus according to the present invention is described using an image forming apparatus such as a multi-function peripheral as an example, but the present invention is not limited to such an image forming apparatus.

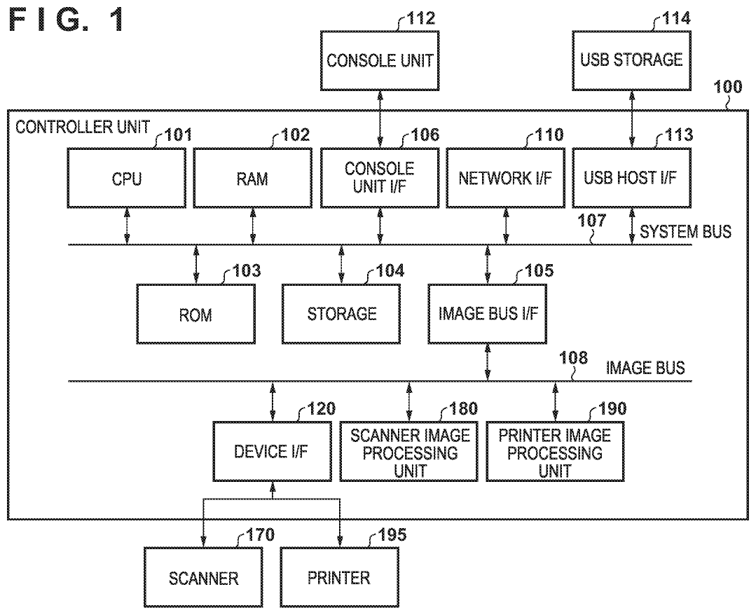

FIG. 1 is a block diagram that describes a configuration of a main part of an image forming apparatus according to an embodiment of the present invention.

This image forming apparatus includes a control unit 100, and a scanner 170, a printer 195 and also a console unit 112 for a user interface are connected to the control unit 100. The control unit 100 can control each unit so as to realize a copy function for printing, by the printer 195, image data read by the scanner 170.

The control unit 100 has a CPU 101, and the CPU 101 executes a stored boot program in a ROM 103, and deploys an operating system (OS) and programs stored in a storage 104 to a RAM 102. The CPU 101 executes a program deployed to the RAM 102, and thereby executes various procedures described below. The CPU 101 further uses the RAM 102 as a working area. The RAM 102 provides the working area as previously described and also provides an image memory region for temporary storage of image data. The storage 104 stores programs, image data, and the like.

The ROM 103, the RAM 102, a console unit I/F (console unit interface) 106, a network I/F (network interface) 110, a USB host I/F 113, and an image bus I/F (image bus interface) 105 are connected to the CPU 101 via a system bus 107. The console unit I/F 106 is an interface with the console unit 112 that has a touch panel, and outputs, to the console unit 112, image data to be the displayed on the console unit 112 which is received via the system bus 107. Also, the console unit I/F 106 sends information inputted by a user on the console unit 112 to the CPU 101 via the system bus 107. The network I/F 110 is an interface for connecting the image forming apparatus to a LAN. The USB host I/F 113 communicates with a USB storage 114, stores data in the USB storage 114 according to instructions from the CPU 101, and reads data stored in the USB storage 114 and outputs the data to the system bus 107. The USB storage 114 is an external storage device that stores data, and is removable from the USB host I/F 113. A plurality of USB devices including the USB storage 114 can be connected to the USB host I/F 113.

The image bus I/F 105 connects the system bus 107 and an image bus 108 that the transfers image data at high-speed, and functions as a bus bridge to convert data formats. The image bus 108 is configured according to PCI bus or IEEE 1394 or the like. A device I/F 120, a scanner image processing unit 180, and a printer image processing unit 190 are arranged on the image bus 108. The scanner 170 and the printer 195 are connected to the device I/F 120 and the device I/F 120 performs synchronous/asynchronous conversion of image data. The scanner image processing unit 180 corrects, processes, and edits image data inputted from the scanner 170. The printer image processing unit 190 corrects, performs resolution conversions, and the like according to the printer 195 on image data to be outputted to the printer 195.

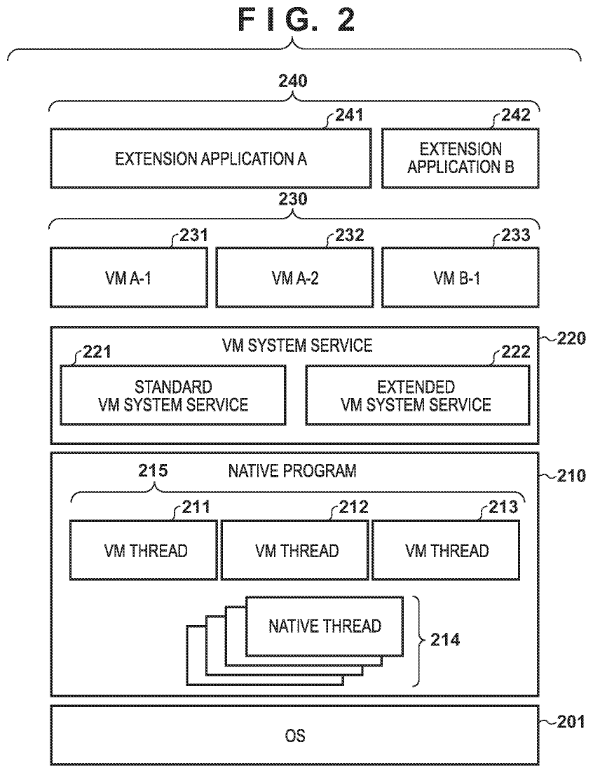

FIG. 2 is a block diagram for describing one example of an extension application execution environment in the image forming apparatus according to the embodiment. Note, functions of each module illustrated in FIG. 2 are realized by the CPU 101 deploying a program stored in the storage 104 to the RAM 102 and executing it.

This image forming apparatus is an image forming apparatus that can extend these functions by installing an extension application as an add-in. Native programs 210 for controlling an image processing unit such as a printer, a FAX, or a scanner and a virtual machine (VM) 230 which is an execution environment of an extension application 240 operate on an OS (operating system) 201. The VM 230 is a module for interpreting and executing a program which controls the extension application 240. The extension application 240 always operates on the VM 230. A program operating on the VM 230 operates according to dedicated commands of the VM 230, which are different to commands dedicated to the CPU 101. These commands are called bytecode. On the other hand, dedicated commands of the CPU are called native code. The native code and the bytecode of the VM 230 operate on the CPU 101 by the VM 230 sequentially interpreting and processing the bytecode. The VM 230 may be of a type that sequentially interprets and processes the bytecode as is or of a type that converts the bytecode into the native code and executes the native code. Although the VM 230 according to the embodiment is the former type, it may also be the latter type. In general, just as the commands for operation by different types of CPUs are not compatible, the commands for operation by different types of VMs are not compatible. Also, although the VM 230 according to the embodiment is a software module operating on the CPU 101, it may be a hardware module.

The native programs 210 include native threads 214 for controlling each image processing unit such as a printer, a FAX, or a scanner and a VM thread 215 for running the VM 230. There are a number of VM threads 215 corresponding to the number of VMs 230. Here, three threads, VM threads 211, 212, and 213, are generated. Here, the three VM threads 211, 212, and 213 correspond to a virtual machine VM A-1 (231), a virtual machine VM A-2 (232), and a virtual machine VM B-1 (233).

A VM system service 220 is a utility library commonly used by the extension application 240. By calling a function of the VM system service 220 from the extension application 240, it is possible to access each module of the image forming apparatus while eliminating work for developing an extension application. A standard VM system service 221 that operates as a minimum VM, and an extension VM system service 222 that provides access to each module of the image forming apparatus and OS functions are included in the VM system service 220. The standard VM system service 221 also includes a function for loading an extension application. The VM system service associated with an API is called when the VM 230 executes the API that is designated in the bytecode of the extension application. The extension application 240, by using the extension VM system service 222, can obtain configuration information such as configuration information of the image forming apparatus, for example, a printable sheet size list, whether color printing is possible, whether a color determination for print data is possible, and a range of a number of copies. Also, it is possible to obtain default setting values corresponding to these.

The VM 230 executes the extension application 240. The VM 230 is generated for every thread of the extension application. In the figure, the VM A-1 (231) and the VM A-2 (232) for running two VM threads 211 and 212 in the extension application A241, and the VM B-1 (233) for running one VM thread 213 in the extension application B242 have been generated.

Also, icons for respective extension applications are displayed on a main menu screen which is displayed on the console unit 112 of the image forming apparatus. When the console unit I/F 106 detects a user's selection of an icon through the console unit 112, the console unit I/F 106 notifies that to the CPU 101. The CPU 101, after accepting this notification, activates the extension application corresponding to the icon selected by the user.

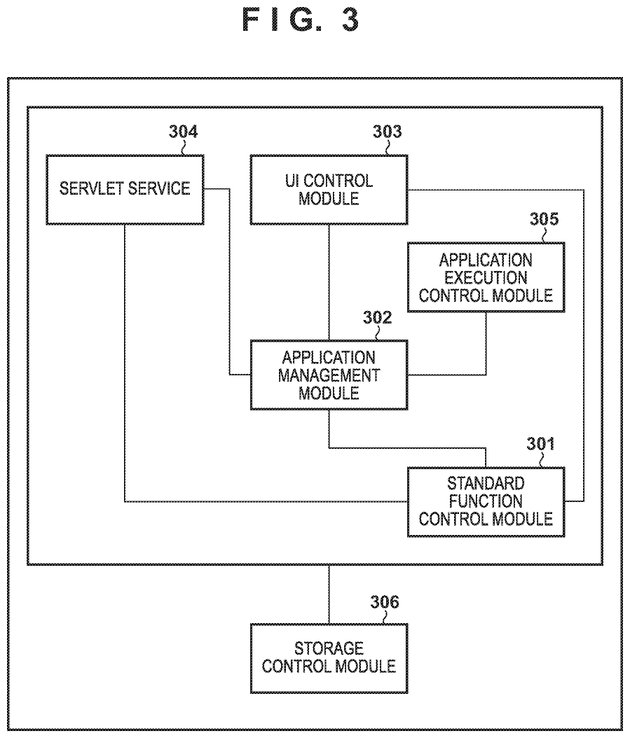

FIG. 3 is a software module configuration diagram that the CPU 101 of the image forming apparatus according to the embodiment executes.

When an HTTP access is made to a servlet service 304 through the network I/F 110, the servlet service 304 accepts the access and assigns processing to a module (an application management module 302 or a standard function control module 301) in accordance with the accessed URL. A UI control module 303 displays a screen on the console unit 112, accepts an operation from the user, and notifies information about the operation to the appropriate module (the application management module 302 or the standard function control module 301). The application management module 302 is a module that performs management such as uninstallation or activation of an installed extension application. An application execution control module 305 is a module that performs control of execution of an application activated by the application management module 302. Specifically, the application execution control module 305 controls the VM thread 215, the VM system service 220, the VM 230, and the extension application 240. A storage control module 306 is a module for storing and managing setting information of the image forming apparatus. Each module accesses the storage control module 306 and references and sets setting values. The standard function control module 301 is a module that performs control of copying and FAX which are standard functions of the image forming apparatus and control necessary for another image forming apparatus (control of the USB host I/F 113, for example).

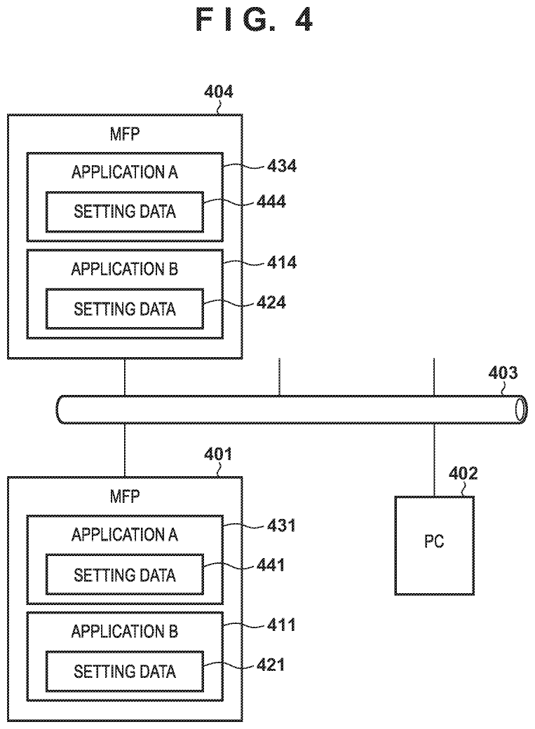

FIG. 4 depicts a view illustrating a configuration example of a print system which includes the image forming apparatus according to the embodiment. The print system includes image forming apparatuses (MFPs) 401 and 404 and a PC 402, and these are connected via a network 403 such as a LAN.

Extension programs (an application A and an application B) for extending functionality of the image forming apparatus are respectively installed on the image forming apparatuses 401 and 404. The PC 402 accesses the image forming apparatuses 401 and 404 and performs setting of the installed applications. Here, an application A 431 of the image forming apparatus 401 and an application A 434 of the image forming apparatus 404 are the same application. Also, these application As 431 and 434 have setting data 441 and 444, respectively, and the configuration of these setting data mutually differ in accordance with differences in the functions of the image forming apparatuses 401 and 404. Also, an application B 411 of the image forming apparatus 401 and an application B 414 of the image forming apparatus 404 are the same application, and setting data 421 and 424 held by them, similarly to the setting data 441 and 444, respectively, mutually differ in accordance with the functions of the image forming apparatuses 401 and 404.

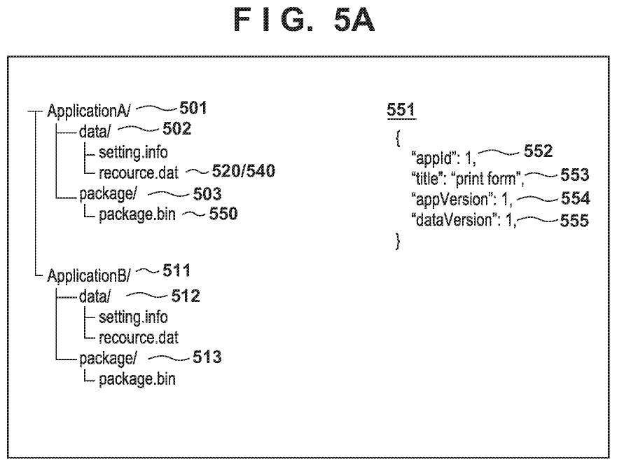

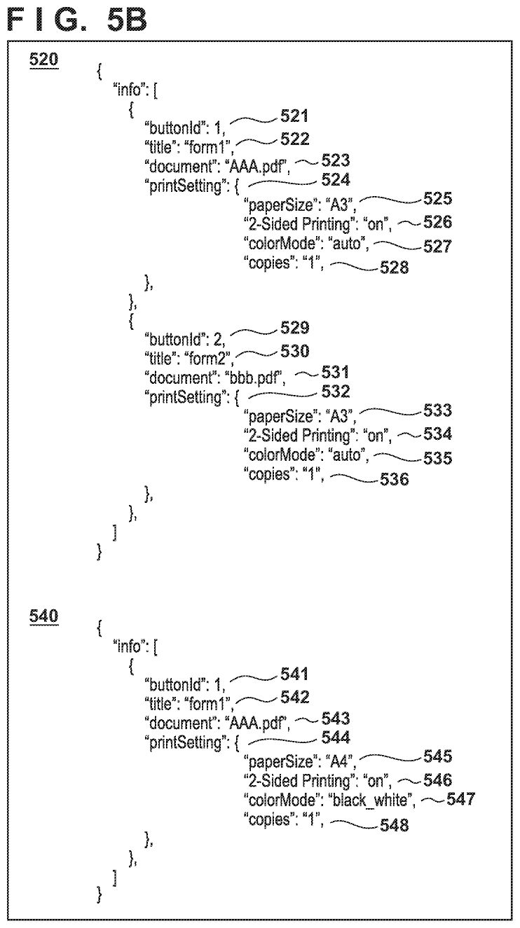

FIGS. 5A and 5B depict views illustrating one example of information of an extension application stored in the storage 104 of the image forming apparatus according to the embodiment.

The storage 104 is managed by the file system and holds a directory structure. Data of the applications is divided and managed in directories for each application. Data of the application A is stored in the directories indicated by reference numerals 501 to 503.

The directory 501 of “Application A” is a root directory for managing the data of the application A. The root directory of the application has a data directory 502 and a package directory 503. The data directory 502 is a directory that holds information for dynamically generating application setting information and the like. What information is written in this data directory and what data format it is written in differs depending on the application. In the embodiment, a form printing application for printing form image data registered by the user will be described as an example of the application. Setting data of the form printing application is stored in “setting.info” 520 and 540.

The setting data 520 in FIG. 5B describes an example of setting data of an image forming apparatus capable of color printing and black and white printing, and the setting data 540 in FIG. 5B describes an example of setting data of an image forming apparatus capable of only black and white printing. Here, although one example of the setting data is indicated by the JSON (JavaScript Object Notation) format, the format of the setting information may be freely decided by the application, for example, may be an independent binary form or XML (Extensible Markup Language).

Also, button IDs 521, 529, and 541 for when displaying icons on the console unit 112, form names 522, 530, and 542, print files 523, 531, and 543, and print settings 524, 532, and 544 are included in the setting data 520 and 540. The button IDs 521, 529, and 541 are IDs that identify icons and are used when identifying a pressed button. The form names 522, 530, and 542 are names that indicate content of a form and the form names 522, 530, and 542 are registered by the user. Here, the form names 522 and 542 are “form 1” and the form name 530 is set to “form 2”. An image file for this form name is an image file to be printed by form printing, and is registered by the user.

Sheet sizes 525, 533, and 545, double-sided settings 526, 534, and 546, print color settings 527, 535, and 547, number of print copies settings 528, 536, and 548 are included in print settings 524, 532, and 544. Here, the print color settings 527 and 535 are print settings in color and black and white modes, and the print color setting 547 is a print setting in black and white.

The package directory 503 in FIG. 5A is a directory for storing static information such as a script file for describing an operation of the application or a resource file of image data displayed on a screen. Script file, resource file, and the like are archived to one file: package.bin 550. Application information 551 in FIG. 5A is included in the package.bin 550. An application identification ID 552, an application name 553, an application version 554, and a data version 555 for identifying an application are included in the application information 551.

Data of the application B is stored in the directories indicated by reference numerals 511 to 513.

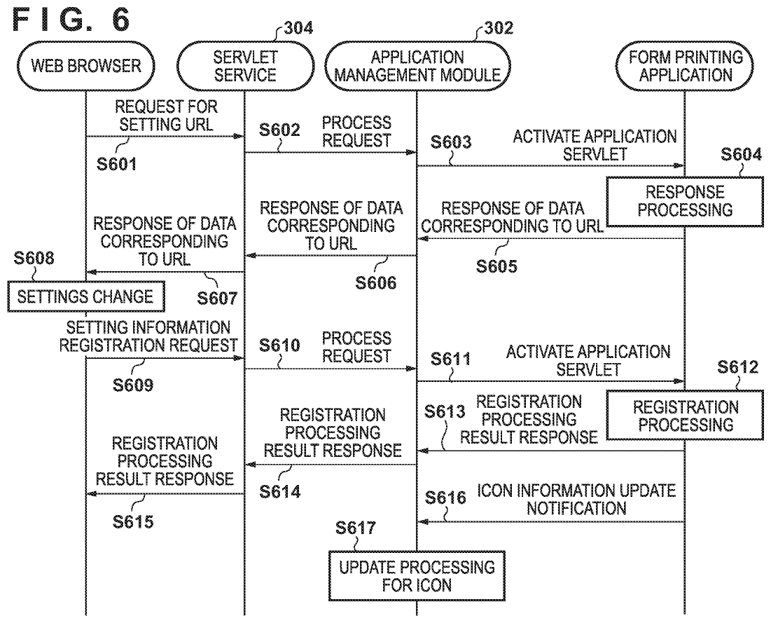

FIG. 6 is a sequence diagram for describing a flow of setting processing of an application in the image forming apparatus 401 according to the embodiment. Hereinafter, processing for generation of icon information of a form printing application for printing form image data registered by the user will be described as an example of the application. Although the detailed processing contents differ depending on the application, the basic processing is the same as the processing shown here. Settings for an application are performed via the Web browser by connecting to the image forming apparatus 401 from the Web browser which operates on the PC 402.

Firstly, a request to a servlet service 304 of the image forming apparatus 401 for a setting URL for making settings of an application is made from the Web browser in step S601. Then, in step S602, the servlet service 304 makes a request to the application management module 302 for processing. Then, the application management module 302 identifies the relevant application from the requested URL and activates an application servlet of the relevant application (form printing application) in step S603. Then, the application (form printing application), in step S604, performs processing for a response to the URL request. Here, preparation for returning an HTML resource corresponding to the setting URL is performed. In this HTML resource, an HTML form for referring to and setting the setting data 520 and 540 necessary for the form printing process is described. Also, setting range information of each item of the setting data 520 and 540 is included therewithin. The setting range information is generated by obtaining configuration information of the image forming apparatus 401 by using the extension VM system service 222.

For the sheet sizes 525, 533, and 545, a setting range is determined from a list of printable sheet sizes. For the print color settings 527, 535, and 547, a setting list is determined from two pieces of information: whether color printing is possible and whether color determination of print data is possible. In a case where color printing is not possible, the print color settings 527, 535, and 547 are not subject to reference and setting and are not described in the HTML form. For the number of print copies settings 528, 536, and 548, an upper limit value and a lower limit value are determined from the range of the number of copies.

Next in step S605, the form printing application responds with the HTML resource prepared in step S604. By this, the application management module 302 of the image forming apparatus 401 responds with the response it has received, as is, to the servlet service 304 in step S606. Also, the servlet service 304 responds with the response it has received, as is, to the Web browser in step S607.

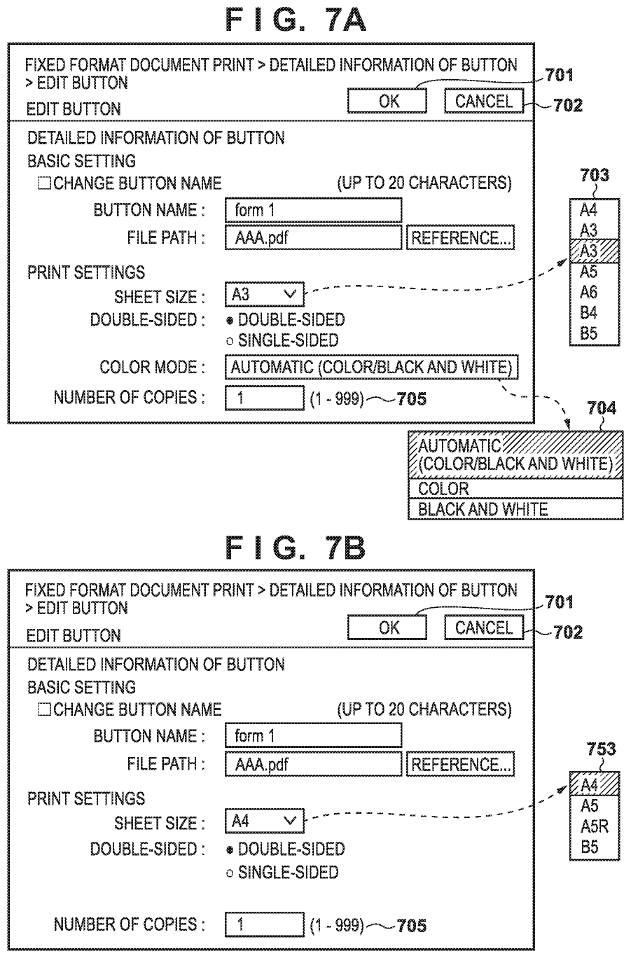

By this, the user of the PC 402 edits the screen displayed on the Web browser and changes the settings of the form printing application in step S608. An example of a screen displayed in this way is illustrated in FIGS. 7A and 7B described below. Here, a print form is newly registered. Then, in step S609, the Web browser transmits a request to register the newly set settings information to the servlet service 304 in accordance with an operation by the user. By this, the servlet service 304 requests for registration processing to the application management module 302 in step S610. By this, the application management module 302 identifies the relevant application from the requested URL and activates the application servlet of the application in step S611. By this, the application (form printing application) in step S612 executes processing for registering the settings of the form printing application based on the request sent from the Web browser. At this time, the form printing application adds a row to the setting data 520 and 540 and registers it. Next, in step S613, the form printing application returns the result of the registration processing to the application management module 302 as a response. By this, the application management module 302 returns the response it received, as is, to the servlet service 304 in step S614. Also, the servlet service 304 returns the response it received, as is, to the Web browser in step S615.

Additionally, in step S616, the form printing application sends an icon information update notification to the application management module 302 in order to register an icon of a newly registered form. By this, the application management module 302 performs the icon update processing in step 5617.

FIGS. 7A and 7B depict views respectively illustrating examples of a settings screen of the form printing application displayed on the Web browser according to the embodiment.

FIG. 7A illustrates one examples of a settings screen for an image forming apparatus which is capable of printing on a sheet up to an A3 size and capable of color printing and black and white printing. Also, FIG. 7B illustrates one example of a settings screen of an image forming apparatus capable of printing on a sheet up to an A4 size which is smaller than the A3 size and capable of only black and white printing.

On the settings screen, when an OK button 701 is pressed, a setting information registration request indicated in step S609 of FIG. 6 is transmitted to the image forming apparatus 401. On the other hand, when a cancel button 702 is pressed, editing is stopped and the registration request is not transmitted. Here, FIG. 7A corresponds to the setting data 520 of FIG. 5B and FIG. 7B corresponds to the setting data 540 of FIG. 5B.

A list 703 of printable sheet sizes of FIG. 7A is a list for selecting a print size. In this example, sheet sizes up to the A3 size are included in the list 703. A list 753 of sheet sizes of FIG. 7B is a list for selecting a print size. In this example, sheet sizes up to the A4 size are included in the list 753. A list 704 of print color settings of FIG. 7A is a list of print color settings. Since the setting screen of FIG. 7B is a screen of an image forming apparatus capable of only black and white printing, the print color setting list is not displayed. A range of the number of copies 705 indicates an upper limit value and a lower limit value for the number of print copies setting.

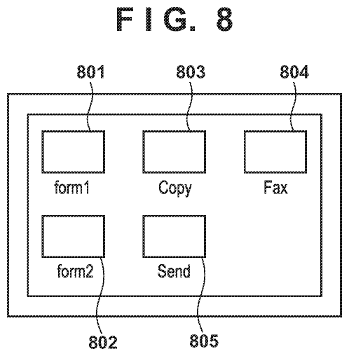

FIG. 8 depicts a view illustrating a screen example which is displayed on the console unit 112 of the image forming apparatus according to the embodiment.

A “form 1” icon 801 is an icon corresponding to a button ID 521 of the form printing application. Also, a “form 2” icon 802 is an icon corresponding to a button ID 529 of the form printing application. Additionally, the screen also includes a copy icon 803, a FAX icon 804, and a Send icon 805 for standard functions. When the user presses one of these icons, the corresponding function is activated.

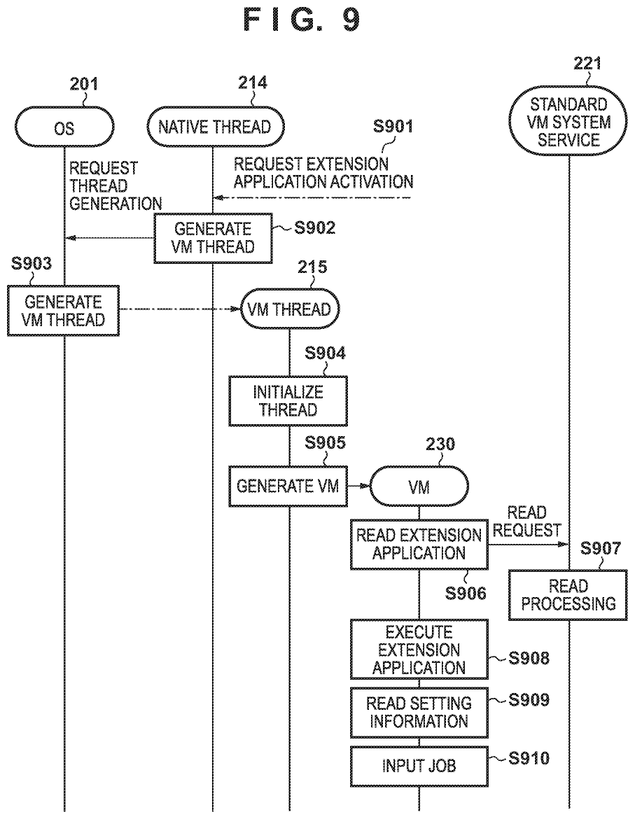

FIG. 9 is a sequence diagram for describing a process when an extension application is activated in the image forming apparatus according to the embodiment.

When it is detected that the user has pressed the icon corresponding to the extension application on the screen displayed on the console unit 112 shown in FIG. 8, the native thread 214 is notified of the request to activate the extension application in step S901. This notification includes the application identification information of the pressed button and the button ID. The native thread 214 which received this notification performs processing for generating the VM thread 215 in step S902. In this processing, a request to generate a thread is issued to the OS 201. The OS 201, having received this thread generation request, generates the VM thread 215 in step S903.

In this way, the generated VM thread 215 performs initialization of the thread in step S904. Subsequently, the VM 230 is generated in step S905. The generated VM 230 executes processing for reading the extension application in step S906. Here, a request to read the extension application is issued to the standard VM system service 221. The application identification information is included in this read request and instructs which application to read. The standard VM system service 221, having received this read request, loads data of the extension application to the VM 230 in step S907. At this time, data of the extension application to be loaded has a fixed name common to each extension application, and each extension application always has data of that name.

Subsequently, the VM 230 executes the loaded extension application in step S908. The processing contents of step S908 differ depending on the contents of the script of the extension application. At this time, the extension application is notified of the button ID indicating which button has been pressed. The extension application determines which icon has been pressed based on information of the notified button ID, and executes the processing corresponding to the button. In a case that a button of form printing has been pressed, the form printing application reads the setting data 520 and 540 in step S909, and recognizes what kind of setting has been made in the application. Also, based on the notified button ID, setting information relating to this button ID is extracted. Subsequently, based on the extracted setting information, a job for performing printing of a form is inputted in step S910. By this processing, the form printing application can print the registered form.

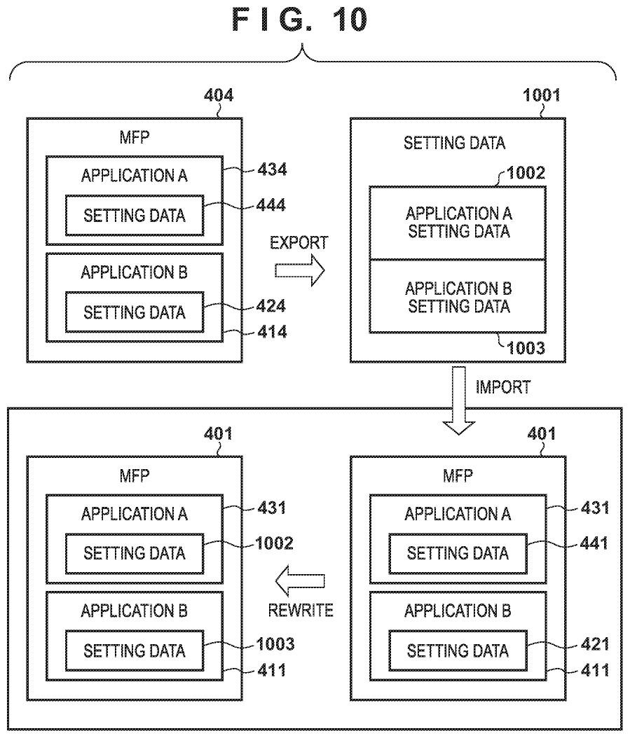

FIG. 10 depicts a view for describing an overview of processing for reflecting application setting information of the image forming apparatus 404 to the image forming apparatus 401 according to the embodiment.

Firstly, setting data 1001 is generated from the application setting data 424 and 444 set in the image forming apparatus 404. Setting data 1002 for restoring the setting data 444 of the application A 434 and setting data 1003 for restoring the setting data 424 of the application B 414 are included in the setting data 1001. This processing is performed by the application management module 302 rather than the application.

Specifically, based on the files of the data directories 502 and 512 of the application illustrated in FIG. 5A, the setting data 1002 and 1003 are generated. At this time, the application management module 302 performs processing without identifying the file type (setting data or resource data). By importing and reflecting the setting data 1001 in the image forming apparatus 401, the setting data of the image forming apparatus 401 is rewritten from the setting data 441 of the application A 431 to the setting data 1002, and the setting data 421 of the application B 411 is rewritten to the setting data 1003. This processing for rewriting as well is performed by the application management module 302. Note, in a case where a corresponding application does not exist, reading of the setting data is not executed.

Generating the setting data 1001 from the current setting data 424 and 444 of the image forming apparatus 404 is an export, and reflecting the setting data to the image forming apparatus 401 based on the setting data 1001 is an import. In the case of the form printing application, the setting data 444 corresponds to the setting data 520 of FIG. 5B and the setting data 424 corresponds to the setting data 540 of FIG. 5B.

Next, in this way, conversion of setting data when setting data having different configuration information is imported to the image forming apparatus 401 is be described with a specific example.

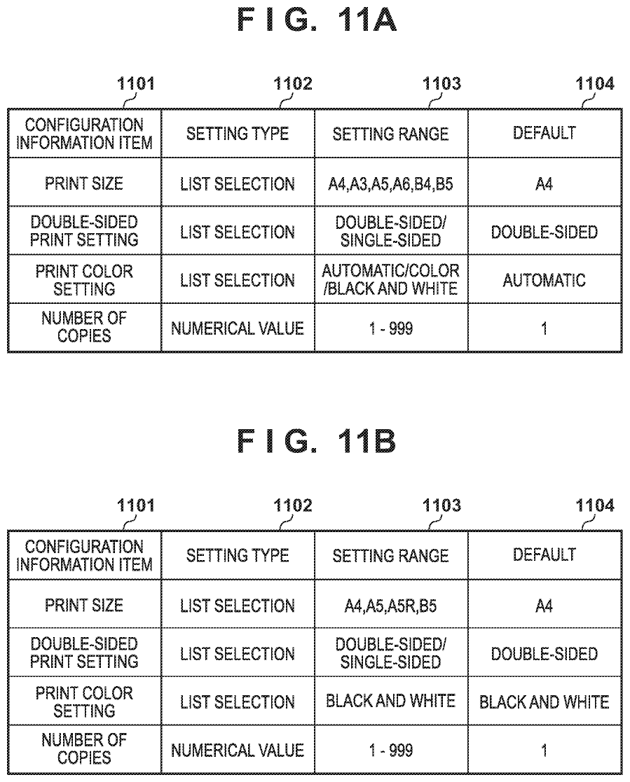

FIGS. 11A and 11B depict views respectively illustrating an example of configuration information of the image forming apparatus 401, which is obtained by the extension application using the extension VM system service 222 according to the embodiment.

FIG. 11A depicts a view illustrating one example of configuration information in which printing on a sheet up to the A3 size is possible and color printing and black and white printing are possible, and FIG. 11B is a view illustrating one example of configuration information in which printing on a sheet up to the A4 size which is smaller than the A3 size is possible and only black and white printing is possible. FIG. 11A corresponds to the setting example on the screen of FIG. 7A, and FIG. 11B corresponds to the setting example on the screen of FIG. 7B.

An item 1101, a setting type 1102, a setting range 1103, and a default setting 1104 are included in the configuration information. The setting type 1102 may be a type (list selection) where a selection is made from the setting range 1103 which is displayed in a list, and there is a type (numerical value) in which a numerical value is set from the setting range 1103. Items for which the setting type 1102 is list selection and that has only one option and items for which the setting type 1102 is a numerical value and whose upper limit value and lower limit value are the same value are fixed settings.

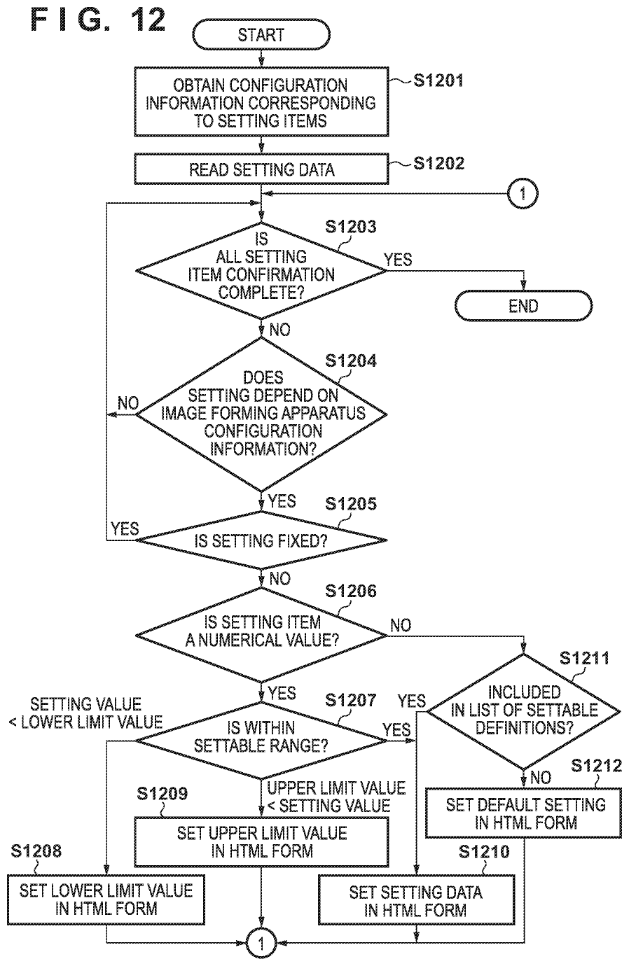

FIG. 12 is a flowchart for describing processing for determining setting data described in an HTML form when setting of an application is executed in a state where setting data having different configuration information is imported in the image forming apparatus 401 according to the embodiment. The processing shown in this flowchart is processing performed when the extension application executes response processing in response to a request for a URL made by the application management module 302 in step S604 of FIG. 6. The processing illustrated in each step is executed by the CPU 101 of the image forming apparatus 401 executing the extension application.

Firstly, in step S1201, the CPU 101 obtains configuration information of the image forming apparatus 401 by using the extension VM system service 222. Next, the processing advances to step S1202 and the CPU 101 reads the setting data 520 and 540. Then, the processing advances to step S1203 and the CPU 101 determines whether or not confirmation of every setting item of the setting data 520 and 540 is completed. In a case where the confirmation is not completed, the processing advances to step S1204, and in a case where the confirmation has completed, this flowchart ends.

In step S1204, the CPU 101 determines whether or not the setting depends on the configuration information of the image forming apparatus 401. In the embodiment, for example, the settings which depend on the configuration information of the image forming apparatus 401 are the print settings 524, 532, and 544 of FIG. 5B, and the settings which do not depend on the configuration information of the image forming apparatus 401 are the button IDs 521, 529, and 541, the form names 522, 530, and 542, and the print files 523, 531, and 543. In step S1204, in a case where it is determined that the settings depend on the configuration information of the image forming apparatus 401, the processing advances to step S1205, and when this is not the case, the processing returns to step S1203. In step S1205, the CPU 101 determines whether or not it is a fixed setting from an item of the configuration information corresponding to the setting item. Here, in a case where it is determined that a fixed setting is set, the processing advances to step S1203, and when this is not the case, the processing advances to step S1206.

In step S1206, the CPU 101 determines whether or not a setting item from the item of the configuration information corresponding to the setting item is a numerical value. Here, in a case where it is determined to be a numerical value, the processing advances to step S1207, and when it is not a numerical value, in other words, in a case where it is determined that it is a selection from a list, the processing advances to step S1211. In step S1207, the CPU 101 compares the setting value of the setting item with the setting range 1103 of the configuration information of the image forming apparatus 401. Here, in a case where the setting value is smaller than the lower limit value of the setting range, the processing advances to step S1208, and in a case where the setting value is larger than the upper limit value of the setting range, the processing advances to step S1209, and in a case where the setting value is within the setting range, the processing advances to step S1210. In step S1208, the CPU 101 sets the setting data described in an HTML form to the lower limit value of the setting range 1103 of the configuration information and then returns the processing to step S1203. In step S1209, the CPU 101 sets the setting data described in an HTML form to the upper limit value of the setting range 1103 of the configuration information and then returns the processing to step S1203. In step S1210, the CPU 101 sets the setting data 520 and 540 as is to the setting data described in the HTML form and then returns the processing to step S1203.

Meanwhile, in a case of a selection from a list, the CPU 101, in step S1211, determines whether or not the setting data 520 and 540 are included in a list of a setting range of the configuration information of the image forming apparatus 401 corresponding to the setting item. Here, in a case where it is determined that the setting data 520 and 540 are included in the list, the processing advances to step S1210, and when this is not the case, the processing advances to step S1212. In step S1212, the CPU 101 sets the setting data described in an HTML form to a default value of the configuration information of the image forming apparatus 401 and then returns the processing to step S1203.

By virtue of the embodiment as described above, by determining the setting data described in the HTML form based on configuration information, even when setting data whose configuration information is different is imported to the image forming apparatus 401, setting screens according to the configuration of the image forming apparatus 401 can be generated and displayed as the setting screens of FIGS. 7A and 7B, for example.

Furthermore, when the OK button 701 is pressed on the setting screen corresponding to the configuration of the image forming apparatus 401 and the registration processing is performed in step S612 based on the request sent from the Web browser, the extension application 240 overwrites the setting data 520 and 540 by the setting values based on that request. By doing so, setting data whose configuration information is different are converted, from their state when they were imported into the image forming apparatus 401 in, into setting data in conformity with the configuration information of the image forming apparatus 401, and the result is reflected.

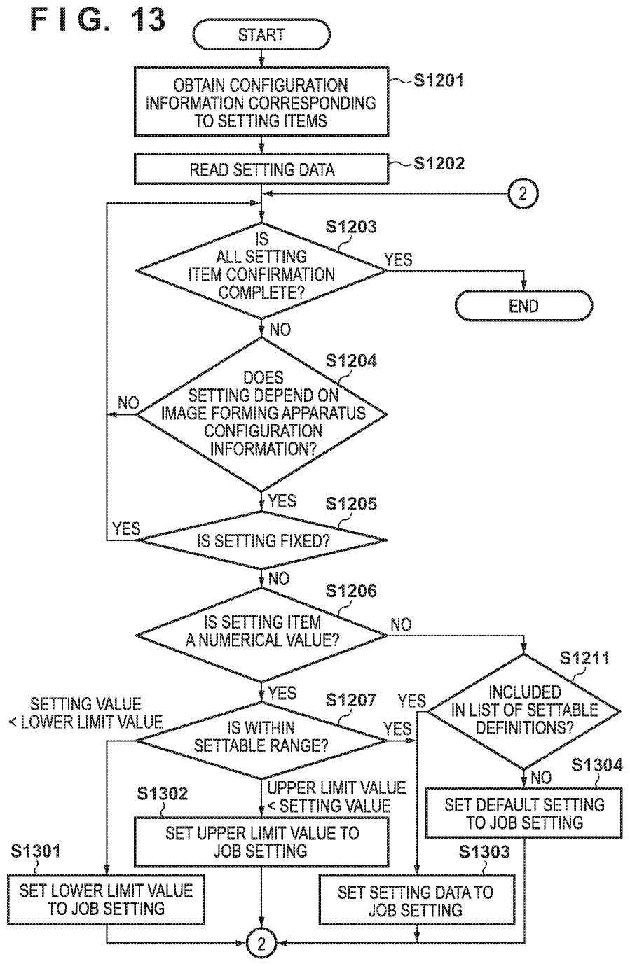

FIG. 13 is a flowchart for describing processing, in the image forming apparatus 401 according to the embodiment, which is performed when the form printing application inputs a j ob, where setting data whose configuration information is different is imported. The processing described in this flowchart is executed by the CPU 101 which executes the extension application. The processing illustrated in this flowchart is executed in step S909 of FIG. 9. Here, the extension application reads the setting data 520 and 540 in step S909 of FIG. 9, and when recognizing what settings are set in the application, executes the processing of step S1201 to step S1207 and step S1211 illustrated in the flowchart similar to FIG. 12. Accordingly, in FIG. 13, the same processing as the processing of FIG. 12 is given by the same reference numerals, and the description thereof will be omitted.

In step S1207, the CPU 101 compares the setting value of the setting item with the setting range 1103 of the configuration information of the image forming apparatus 401. Here, in a case where the setting value is smaller than the lower limit value of the setting range, the processing advances to step S1301, and in a case where the setting value is larger than the upper limit value of the setting range, the processing advances to step S1302, and in a case where the setting value is within the setting range, the processing advances to step S1303. In step S1301, the CPU 101 sets the setting data for inputting a job to the lower limit value of the setting range 1103 of the configuration information of the image forming apparatus 401 and returns the processing to step S1203. In step S1302, the CPU 101 sets the setting data for inputting a job to the upper limit value of the setting range 1103 of the configuration information of the image forming apparatus 401 and returns the processing to step S1203. In step S1303, the CPU 101 sets the setting data 520 and 540 as is to the setting data for inputting a job and then returns the processing to step S1203.

Also, the CPU 101, in step S1211, determines whether or not the setting data 520 and 540 are included in a list of the setting range of the configuration information corresponding to the setting item. Here, in a case where it is determined that the setting data 520 and 540 are included in the list, the processing advances to step S1303, and when this is not the case, the processing advances to step S1304. In step S1304, the CPU 101 sets the setting data for inputting a job to the default value of the configuration information and returns the processing to step S1203.

In other words, the setting data 520 and 540 are not overwritten simply by executing the job, and the setting data whose configuration information is different are maintained in the state in which they were imported into the image forming apparatus 401.

By virtue of the embodiment as described above, the setting data can be imported without starting the extension application, and when the extension application is started, it is determined whether or not setting items are different, and or setting value ranges are different, and then settings data is converted. By this, it is possible for a user to immediately use an application even when importing setting values.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-147964, filed Aug. 9, 2019, which is hereby incorporated by reference herein in its entirety.

What is claimed is:

1. An information processing apparatus being capable of extending functions by installing an extension application as an add-in, the information processing apparatus comprising:
at least one processor and at least one memory configured to function as:
a management unit that stores and manages setting data of each application;
a rewriting unit that reads setting data of an application of another device and rewrites setting data of a corresponding extension application that the information processing apparatus has;
an editing unit that activates the extension application and edits the setting data; and
a converting unit that, in a case that the setting data is edited by the editing unit, in a case where a setting value of the setting data differs between the another device and the information processing apparatus, converts the differing setting value to a setting value based on configuration information of the information processing apparatus.

2. The information processing apparatus according to claim 1, wherein the converting unit, in a case where the differing setting value is not within a setting range based on the configuration information of the information processing apparatus and the differing setting value is a numerical value, converts the differing setting value to a lower limit value or an upper limit value in accordance with whether the differing setting value is smaller than the lower limit value or larger than the upper limit value of the setting range.

3. The information processing apparatus according to claim 1, wherein the converting unit, in a case where the differing setting value is not a value that is able to be set based on the configuration information of the information processing apparatus, converts the differing setting value into a default setting value.

4. The information processing apparatus according to claim 1, wherein the editing unit displays a screen for editing the setting data and the screen includes the setting value resulting from the conversion by the converting unit.

5. The information processing apparatus according to claim 3, wherein the editing unit displays a screen for editing the setting data and, in a case where the differing setting value is not included in setting items that can be set based on the configuration information of the information processing apparatus, the screen does not include the setting item.

6. The information processing apparatus according to claim 1, wherein the information processing apparatus has a native program and a virtual machine that is a module that interprets and executes a program that controls the extension application, and the native program and the virtual machine operate on an OS (operating system).

7. An information processing apparatus being capable of extending functions by installing an extension application as an add-in, the information processing apparatus comprising:
at least one processor and at least one memory configured to function as:
a management unit that stores and manages setting data of each application;
a rewriting unit that reads setting data of an application of another device and rewrites setting data of a corresponding extension application that the information processing apparatus has;
an execution unit that executes, in a case that the extension application is activated, a job by the extension application in accordance with setting data corresponding to the extension application; and
a converting unit that, in a case that the execution unit executes the job, in a case where a setting value of the setting data differs between the another device and the information processing apparatus, converts the differing setting value to a setting value based on configuration information of the information processing apparatus, and sets the result of the conversion to the job.

8. The information processing apparatus according to claim 7, wherein the converting unit, in a case where the differing setting value is not within a setting range based on the configuration information of the information processing apparatus and the differing setting value is a numerical value, converts the differing setting value to a lower limit value or an upper limit value in accordance with whether the differing setting value is smaller than the lower limit value or larger than the upper limit value of the setting range.

9. The information processing apparatus according to claim 7, wherein the converting unit, in a case where the differing setting value is not a value that is able to be set based on the configuration information of the information processing apparatus, converts the differing setting value into a default setting value.

10. The information processing apparatus according to claim 7, wherein the information processing apparatus has a native program and a virtual machine that is a module that interprets and executes a program that controls the extension application, and the native program and the virtual machine operate on an OS (operating system).

11. A method of controlling an information processing apparatus that is able to extend functions by installing an extension application as an add-in, the method comprising:
managing and storing setting data of each application;
reading setting data of an application of another device and rewriting setting data of a corresponding extension application that the information processing apparatus has;
activating the extension application and editing the setting data; and
in a case that the setting data is edited, in a case where a setting value of the setting data differs between the another device and the information processing apparatus, converting the differing setting value to a setting value based on configuration information of the information processing apparatus.

12. A method of controlling an information processing apparatus that is able to extend functions by installing an extension application as an add-in, the method comprising:
managing and storing setting data of each application;
reading setting data of an application of another device and rewriting setting data of a corresponding extension application that the information processing apparatus has;
executing, in a case that the extension application is activated, a job by the extension application in accordance with setting data corresponding to the extension application; and
in a case that the job is executed, in a case where a setting value of the setting data differs between the another device and the information processing apparatus, converting the differing setting value to a setting value based on configuration information of the information processing apparatus, and setting the job.

13. A non-transitory computer-readable storage medium storing a program for causing a processor to execute a method of controlling an information processing apparatus being capable of extending functions by installing an extension application as an add-in, the method comprising:
managing and storing setting data of each application;
reading setting data of an application of another device and rewriting setting data of a corresponding extension application that the information processing apparatus has;
activating the extension application and editing the setting data; and
in a case that the setting data is edited, in a case where a setting value of the setting data differs between the another device and the information processing apparatus, converting the differing setting value to a setting value based on configuration information of the information processing apparatus.

14. A non-transitory computer-readable storage medium storing a program for causing a processor to execute a method of controlling an information processing apparatus that is able to extend functions by installing an extension application as an add-in, the method comprising:
managing and storing setting data of each application;
reading setting data of an application of another device and rewriting setting data of a corresponding extension application that the information processing apparatus has;
executing, in a case that the extension application is activated, a job by the extension application in accordance with setting data corresponding to the extension application; and
in a case that the job is executed, in a case where a setting value of the setting data differs between the another device and the information processing apparatus, converting the differing setting value to a setting value based on configuration information of the information processing apparatus, and setting the job.
